(19) United States
(12) Patent Application Publication
(10) Pub. No.: US 2009/0000588 A1
(43) Pub. Date: Jan. 1, 2009

(54) TORQUE INCREASE RESONATOR

(75) Inventors: Naohito Seko, Kariya-city (JP); Toshiaki Nakayama, Nishikamo-gun (JP); Yoshitaka Nishio, Nagoya-city (JP); Seiji Tachibana, Toyoake-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/137,712

(22) Filed: Jun. 12, 2008

(30) Foreign Application Priority Data
Jun. 28, 2007 (JP) 2007-170464

(51) Int. Cl. F02M 35/10

(52) U.S. Cl. 123/184.57

(57) ABSTRACT

A torque increase resonator for facilitating delivery of intake air to a combustion chamber of an engine by resonating with intake air pulsation generated by the delivery of intake air to the combustion chamber includes a chamber wall. The chamber wall projects in a surge tank of an intake manifold to define a resonance chamber. The resonance chamber is prevented from communicating with intake air. The chamber wall includes a resonating member, which is a thin film and resonates with the intake air pulsation. The chamber wall is integrally formed.

### CROSS REFERENCE TO RELATED APPLICATION

This application is based on and incorporates herein by reference Japanese Patent Application No. 2007-170464 filed on Jun. 28, 2007.

### BACKGROUND OF THE INVENTION

1. Field of the Invention

The present invention relates to a torque increase resonator mounted on an intake system of an engine.

2. Description of Related Art

Conventionally, a torque increase resonator or a resonator has been known to facilitate delivery of intake air to a combustion chamber for improvement of an engine output by resonating with intake air pulsation or with pressure pulses generated by the delivery of intake air to the combustion chamber of the engine.

A conventional resonator 100, as shown in FIG. 5, includes a surge tank 102, a resonance chamber 103, and a communication passage 104. The resonance chamber 103 is provided outside the surge tank 102 of an intake manifold 101, and the communication passage 104 communicates between the surge tank 102 and the resonance chamber 103. The resonator 100 facilitates delivery of intake air to a combustion chamber (not shown) by using a resonant wave generated at the communication passage 104 due to resonance with intake air pulsation (for example, see JP-A-H2-199265).

However, because the resonator 100 requires a mounting space in addition to the intake manifold 101, a mounting region for devices becomes larger in a limited engine room. Thus, the resonator 100 is against a recent need of reducing mounting region of devices in an engine room disadvantageously.

### SUMMARY OF THE INVENTION

The present invention is made in view of the above disadvantages. Thus, it is an objective of the present invention to address at least one of the above disadvantages.

To achieve the objective of the present invention, there is provided a torque increase resonator for facilitating delivery of intake air to a combustion chamber of an engine by resonating with intake air pulsation generated by the delivery of intake air to the combustion chamber, the torque increase resonator including a chamber wall. The chamber wall projects in a surge tank of an intake manifold to define a resonance chamber, and the resonance chamber is prevented from communicating with intake air. The chamber wail includes a resonating member, which is a thin film and resonates with the intake air pulsation. The chamber wall is integrally formed.

To achieve the objective of the present invention, there is also provided a torque increase resonator mounted within a surge tank of an intake manifold, the resonator including a chamber wall. The chamber wall projects from an inner wall of the surge tank of the intake manifold and includes a plurality of resonating members that are integral with each other to define a resonance chamber. The resonance chamber is prevented from communicating with intake air. Each of the plurality of resonating members has a planar outer surface and resonates with pressure pulses of intake air. The plurality of resonating members is integral with each other. One of the plurality of resonating members resonates with the pressure pulses at a first frequency. Another one of the plurality of resonating members resonates with the pressure pulses at a second frequency.

### BRIEF DESCRIPTION OF THE DRAWINGS

The invention, together with additional objectives, features and advantages thereof, will be best understood from the following description, the appended claims and the accompanying drawings in which:

FIG. 1 is an explanatory diagram illustrating an intake manifold having a resonator according to a first embodiment of the present invention;

FIG. 2A is a front view of the resonator of the first embodiment;

FIG. 2B is a cross-sectional view of the resonator taken along line IIB-IIB in FIG. 2A;

FIG. 2C is a side view of the resonator of the first embodiment;

FIG. 2D is a cross-sectional view the resonator taken along line IID-IID in FIG. 2C;

FIG. 3A is a perspective view of a resonator according to a modified embodiment of the present invention;

FIG. 3B is a perspective view of another resonator according to a modified embodiment of the present invention;

FIG. 3C is a perspective view of still another resonator according to a modified embodiment of the present invention;

FIG. 4 is an explanatory diagram illustrating an intake manifold having a resonator according to another modified embodiment of the present invention; and

FIG. 5 is an explanatory diagram of an intake manifold having a resonator according to a conventional art.

### DETAILED DESCRIPTION OF PREFERRED EMBODIMENTS

### First Embodiment

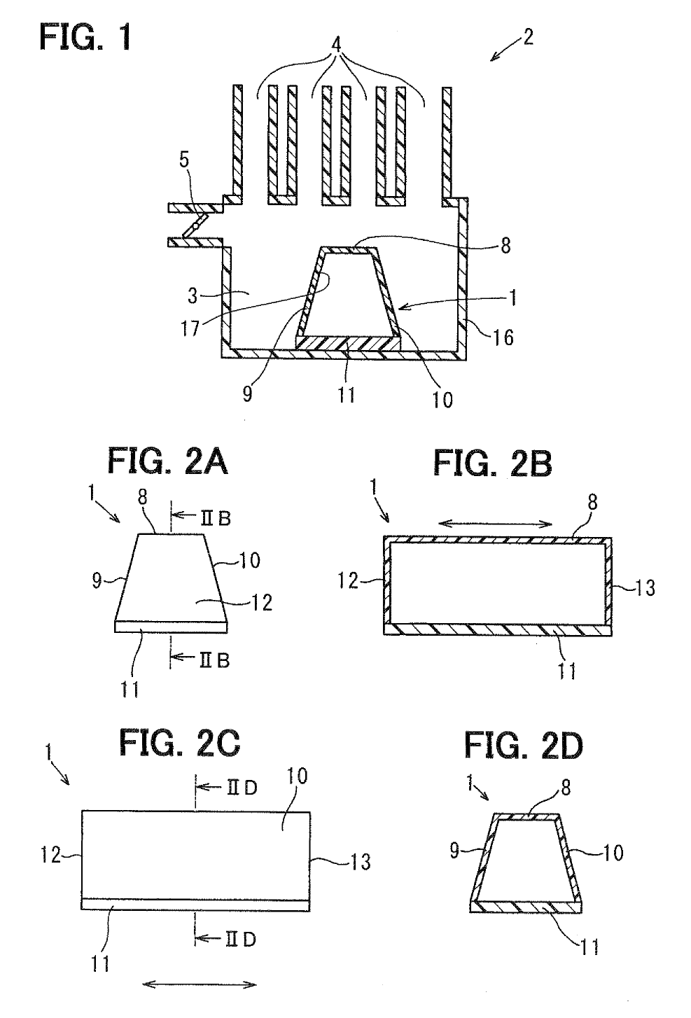

A structure of a resonator 1 according to the first embodiment of the present invention is described with reference to FIGS. 1 to 2D.

The resonator 1 facilitates delivery of intake air into a combustion chamber by resonating with intake air pulsation (pressure pulses) due to the delivery of intake air to the combustion chamber (not shown) of an engine (not shown), and the resonator 1 is assembled within a surge tank 3 of an intake manifold 2 as shown in FIG. 1. It is noted that the intake manifold 2 includes intake ports 4 that communicate between the surge tank 3 and the combustion chamber. Intake air introduced through a throttle valve 5 is delivered to the combustion chamber through the surge tank 3 and the intake ports 4.

The resonator 1 includes six wall portions 8 to 13 to form a hexahedron as shown in FIGS. 2A to 2D. It is noted that an outer surface of each of the six wall portions 8 to 13 is planar. Four wall portions 8 to 11 of the resonator 1 extend along a longitudinal axis (shown in FIGS. 2B, 2C), and, the wall portion 8 is provided in parallel with the wall portion 11. Thus, the resonator 1 has a trapezoidal cross section perpendicular to the longitudinal axis (see FIG. 2D).

Also, the resonator 1 is integrally formed, for example, by injection molding as a separate body separate from a main body wall 16 of the intake manifold 2 (see FIG. 1), and is assembled to the intake manifold 2. In the six wall portions 8 to 13, the three wall portions 8 to 10, which extend along the longitudinal axis, and the two wall portions 12, 13, which are positioned at both longitudinal ends of the resonator 1, project from an inner wall of the surge tank 3 to serve as a chamber wall in a state where the resonator 1 is assembled within the intake manifold 2. As above, the chamber wall defines a resonance chamber 17, which is not communicated with intake air.

In other words, the wall portion 8 to 10, 12, 13 are configured to have thin film shapes, and serve as resonating members that resonate with intake air pulsation or with pressure pulses of intake air. Also, the wall portion 8 to 10, 12, 13 are configured to be mutually different from each other in a specification. It is noted that the specification of the wall portion 8 to 10, 12, 13 includes, for example, a thickness, a mass, an area, a density, and a material. Respective frequency of each of the wail portions 8 to 10, 12, 13 is determined depending on the above specification. In other words, a specific frequency, at which each of the wall portion 8 to 10, 12, 13 is able to resonate, is determined among various frequencies of intake air pulsation.

The wall portion 11 may be thicker than each of the wall portions 8 to 10, 12, 13, for example.

Advantages of the resonator 1 of the first embodiment is described. The resonator 1 of the first embodiment is an integral configuration formed separately from the main body wall 16 of the intake manifold 2, and includes the wall portions 8 to 10, 12, 13, which are thin films, and which project in the surge tank 3 to serve as the chamber wall defining the resonance chamber 17. Further, the wall portions 8 to 10, 12, 13 serve as the resonating members that resonate with intake air pulsation or pressure pulses of intake air.

As above, the resonator 1 is provided inside the surge tank 3, which is a part of the intake manifold 2. As a result, a mounting region of devices in an engine room (not shown) is reduced by a volume of the resonator 1.

Also, because the resonator 1 including the wall portions 8 to 10, 12, 13, which serve as the chamber wall, is integrally formed as the separate body that is separate from the main body wall 16 of the intake manifold 2, the wall portions 8 to 10, 12, 13 serving as the chamber wall provide a continuous wall that does not have a bonding or joining. Thus, the chamber wall is enabled to have a high strength.

Also, by preparing the resonator 1 as the separate body that is separate from the main body wall 16, the shape and the specification of the resonator 1 are enabled be more flexibly determined. In other words, the specification of the resonator 1 is able to be set as required in a limitation range provided that the resonator 1 be received in the surge tank 3 and that the resonator 1 be limited from inhibiting a function of the surge tank 3.

As a result, by maximizing areas of the wall portions 8 to 10, 12, 13 serving as the resonating member within the limitation range, useless or unwanted decay of intake air pulsation is able to be minimized. Also, facilitation of delivery of intake air is able to be maximized. Also, by making each of the wall portions 8 to 10, 12, 13 to be a thin film such that the each serves as the resonating member, weight of the vehicle is able to be saved.

Also, the wall portions 8 to 10, 12, 13 serving as the chamber wall are configured to be mutually different from each other in the specification.

As a result, each of the wall portions 8 to 10, 12, 13 resonates with a corresponding pressure pulse of intake air at a different frequency different from each other. In other words, one of the wall portions 8 to 10, 12, 13 or one resonating member resonates with the intake air pulsation at a first frequency, and another one of the wall portions 8 to 10, 12, 13 or another resonating member resonates with the intake air pulsation at a second frequency. Thus, the number of useless decay of frequencies among the various frequencies of intake air pulsation is reduced, and thereby the resonator 1 is able to efficiently facilitate the delivery of intake air.

### Modified Embodiment

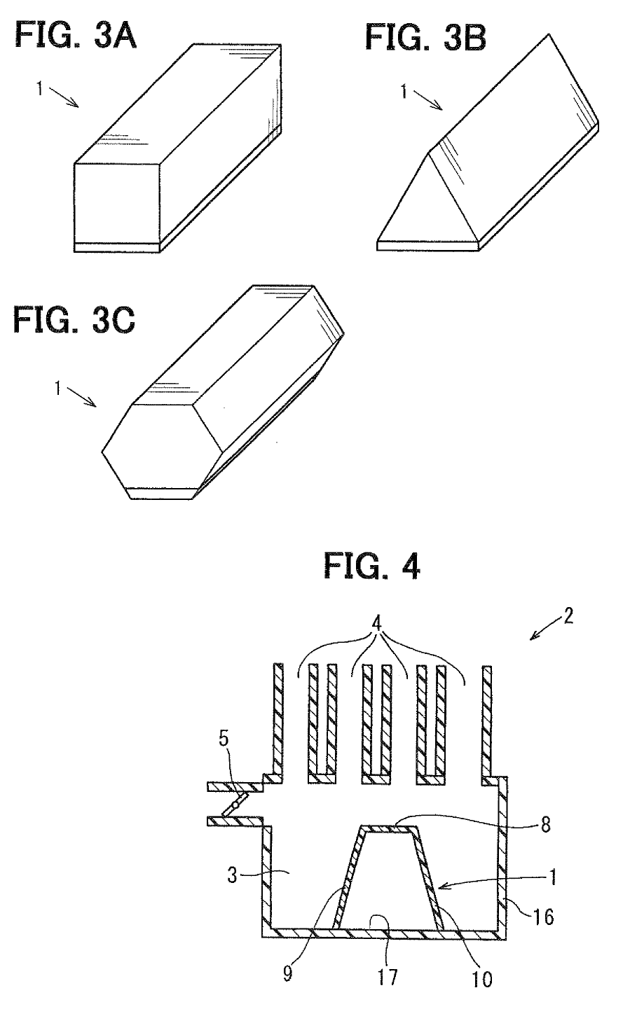

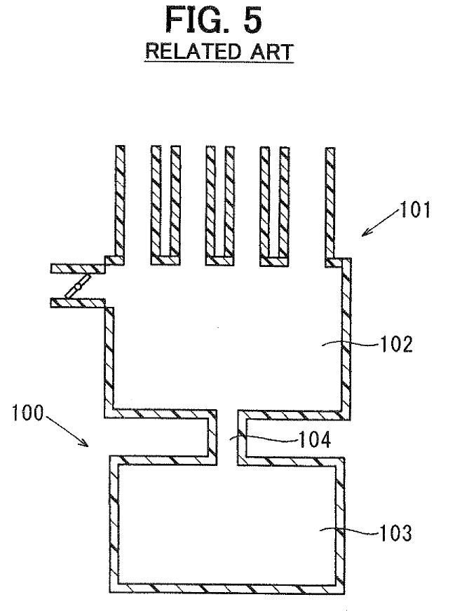

The resonator 1 of the first embodiment is configured to have the trapezoidal cross section taken perpendicularly to the longitudinal axis of the wall portion 8 to 11. However, for example, the resonator 1 may have a square cross sectional shape (see FIG. 3A). Also, the resonator 1 may have a triangular cross sectional shape (see FIG. 3B) or a hexagonal cross sectional shape (see FIG. 3C) by further increasing or reducing the number of walls that extend along the longitudinal axis.

Also, according to the resonator 1 of the first embodiment, each of the wall portions 8 to 10, 12, 13 serving as the chamber wall has a thin film shape and functions as the resonating member. However, for example, only a part of the wall portion 8 and a part of the wall portion 9 may have thin film shapes to function as the resonating members. Alternatively, for example, multiple parts of the wall portion 8 may be configured to have multiple thin film parts of different specifications mutually different from each other such that the wall portion 8 is configured to function as multiple resonating members.

Although, an entire of the resonator 1 of the first embodiment is integrally formed, the resonator 1 may be integrally made from the wall portions 8 to 10, 12, 13, which serve as the chamber wall. In other words, only a part of the resonator 1, which part corresponds to the chamber wall, is made, and the wall portion 11, which does not serve as the chamber wall, may be separately formed. Then, the wall portion 11 may be attached or joined to the above integral structure made by the wall portions 8 to 10, 12, 13 to provide the resonator 1.

Additional advantages and modifications will readily occur to those skilled in the art. The invention in its broader terms is therefore not limited to the specific details, representative apparatus, and illustrative examples shown and described.

What is claimed is:

1. A torque increase resonator for facilitating delivery of intake air to a combustion chamber of an engine by resonating with intake air pulsation generated by the delivery of intake air to the combustion chamber, the torque increase resonator comprising:
a chamber wall that projects in a surge tank of an intake manifold to define a resonance chamber, the resonance chamber being prevented from communicating with intake air, the chamber wall including a resonating member, which is a thin film and resonates with the intake air pulsation, the chamber wall being integrally formed.

2. The torque increase resonator according to claim 1, wherein:
the resonating member of the chamber wall resonates with the intake air pulsation at a first frequency; and
the chamber wall includes another resonating member that resonates with the intake air pulsation at a second frequency.

3. The torque increase resonator according to claim 1, wherein the chamber wall includes a plurality of outer surfaces, each of which is planar.

4. The torque increase resonator according to claim 1, wherein:
the chamber wall is integrally formed as a separate body separate from a main body wall of the intake manifold; and
the chamber wall is provided to project from in the surge tank.

5. The torque increase resonator according to claim 1, wherein the intake air pulsation includes a plurality of pressure pulses of intake air.

6. The torque increase resonator according to claim 1, wherein the chamber wall defines the resonance chamber together with a part of a main body wall of the intake manifold.

7. A torque increase resonator mounted within a surge tank of an intake manifold, the resonator comprising:
a chamber wall that projects from an inner wall of the surge tank of the intake manifold, the chamber wall including a plurality of resonating members that are integral with each other to define a resonance chamber, the resonance chamber being prevented from communicating with intake air, wherein:
each of the plurality of resonating members has a planar outer surface and resonates with pressure pulses of intake air;
the plurality of resonating members is integral with each others
one of the plurality of resonating members resonates with the pressure pulses at a first frequency; and
another one of the plurality of resonating members resonates with the pressure pulses at a second frequency.

8. The torque increase resonator according to claim 7, wherein the plurality of resonating members defines the resonance chamber together with the inner wall of the surge tank.

9. The torque increase resonator according to claim 7, wherein the plurality of resonating members is different from each other in at least one of a thickness, a mass, an area, a density, and a material.
